(19) United States
(12) Patent Application Publication
(10) Pub. No.: US 2018/0015589 A1
(43) Pub. Date: Jan. 18, 2018

(54) GAS-FILLED VESSEL FILLED WITH FLUORINATED HYDROCARBON COMPOUND

(71) Applicant: ZEON CORPORATION, Chiyoda-ku, Tokyo (JP)

(72) Inventor: Yuko KOHINATA, Chiyoda-ku, Tokyo (JP)

(73) Assignee: ZEON CORPORATION, Chiyoda-ku, Tokyo (JP)

(21) Appl. No.: 15/541,529

(22) PCT Filed: Jan. 15, 2016
(86) PCT No.: PCT/JP2016/051112

§ 371 Date: Jul. 5, 2017

(30) Foreign Application Priority Data
Jan. 22, 2015 (JP) 2015-010539

(51) Int. Cl. B24B 31/02; F17C 13/12; B65D 85/84; F17C 1/10

(52) U.S. Cl. CPC B24B 31/0212; F17C 1/10; F17C 13/126; B65D 85/84; F17C 2203/0607; F17C 2209/2172; F17C 2221/032; F17C 2270/0518; F17C 2203/0639

(57) ABSTRACT

The present invention is a fluorohydrocarbon compound-filled gas container obtained by filling a gas container with a fluorohydrocarbon compound, the gas container being made of manganese steel, an amount of aluminum adhering to an inner surface of the gas container as measured by XPS analysis being 1 mol % or less, and the fluorohydrocarbon compound being a compound represented by C₄H₉F or C₅H₁₁F. The present invention provides a fluorohydrocarbon compound-filled gas container that is obtained by filling a gas container with a fluorohydrocarbon compound represented by C₄H₉F or C₅H₁₁F, and suppresses or reduces a decrease in the purity of the fluorohydrocarbon compound with which the gas container is filled.

### TECHNICAL FIELD

The present invention relates to a fluorohydrocarbon compound-filled gas container that is obtained by filling a gas container with a fluorohydrocarbon compound represented by C₄H₉F or C₅H₁₁F.

### BACKGROUND ART

A fluorohydrocarbon compound is used as an etching gas during an etching process used to produce a semiconductor device or the like in order to selectively etch the etching target material.

The fluorohydrocarbon compound used for the etching process is required to have high purity (e.g., 99.90 vol % or more) in order to implement a fine etching process in a stable manner. The fluorohydrocarbon compound is normally stored in a state in which a gas container is filled with the fluorohydrocarbon compound until it is used.

Therefore, the fluorohydrocarbon compound used for the etching process is required to have high purity before the gas container is filled with the fluorohydrocarbon compound, and maintain high purity for a long time during storage.

A gas container made of manganese steel or chromium-molybdenum steel is normally used as the gas container. When minute convexities and concavities are formed on the inner surface of the gas container, water, an impurity gas, metal particles, and the like that may contaminate the gas with which the gas container is filled, may easily adhere to the inner surface of the gas container. Therefore, the inner surface of the gas container that is filled with a high-purity gas is normally subjected to a polishing process until the inner surface of the gas container is mirror-finished.

The inner surface of the gas container may be polished using the following methods, for example.
(i) Patent Literature 1 discloses a method for polishing the inner surface of a hollow container made of a metal. The method disclosed in Patent Literature 1 includes a step that charges the hollow container with polishing media and water, and rotates the hollow container around the center axis to polish the inner surface of the hollow container. Patent Literature 1 discloses a ceramic material such as aluminum oxide, silicon carbide, and zirconium oxide as the polishing media.
(ii) Patent Literature 2 discloses a method for treating the inner surface of a high-pressure gas vessel. The method disclosed in Patent Literature 2 includes a step that wet-grinds the inner surface of the high-pressure gas vessel using an abrasive that includes a rust preventive, and rinses the inner surface of the high-pressure gas vessel using an acidic rinsing solution (i.e., an aqueous solution that includes a salt that shows weak acidity through hydrolysis). Patent Literature 2 discloses that (a) the abrasive that includes a rust preventive is used to solve a problem in which the inner surface of the high-pressure gas vessel is easily oxidized as the roughness of the inner surface of the high-pressure gas vessel decreases, (b) dust (e.g., polishing waste) is adsorbed on the rust prevention film when the abrasive that includes a rust preventive is used, and it is difficult to remove such dust by washing with water, and (c) the process disclosed in Patent Literature 2 suppresses or reduces adsorption of water and oxygen on the inner wall surface of the high-pressure gas vessel, and the silane gas with which the high-pressure gas vessel is filled is rarely decomposed.
(iii) Patent Literature 3 discloses a halogen-based gas container that is characterized in that the inner surface of the container has been processed using an abrasive, and the state of the inner surface of the container is specified by measurement using X-ray photoelectron spectroscopy. Patent Literature 3 discloses that a silicon halide (impurity) decreases the purity of the halogen-based gas, and is produced by the reaction between Si that remains on the inner surface of the container, and the gas with which the container is filled.

### CITATION LIST

### Patent Literature

Patent Literature 1: JP-A-2011-104666

Patent Literature 2: JP-A-09-026093 (U.S. Pat. No. 5,803,795)

Patent Literature 3: JP-A-2004-270917 (US2004/0026417A1)

### SUMMARY OF INVENTION

### Technical Problem

As described above, various methods for polishing the inner surface of a gas container have been proposed.

However, even when the inner surface of a gas container has been polished using these methods, when the gas container is filled with a fluorohydrocarbon compound represented by C₄H₉F or C₅H₁₁F, part of the fluorohydrocarbon compound is decomposed within the gas container with the passing of time to produce a dehydrofluorinated compound (olefin compound), whereby the purity of the fluorohydrocarbon compound may decrease.

When the inner surface of a high-pressure gas container is unnecessarily planarized, the cost and the polishing time increase. In particular, when the roughness (Rmax) of the inner surface of high-pressure gas container is reduced to 3 μm or less, and a rust prevention film is provided (see Patent Literature 2), it is necessary to repeat the polishing process using a different polishing agent, and repeat the washing (rinsing) process under different conditions, whereby an increase in cost and time occurs.

The invention was conceived in view of the above situation. An object of the invention is to provide a fluorohydrocarbon compound-filled gas container that is obtained by filling a gas container with a fluorohydrocarbon compound represented by C₄H₉F or C₅H₁₁F, and suppresses or reduces a decrease in the purity of the fluorohydrocarbon compound with which the gas container is filled.

### Solution to Problem

The inventor conducted extensive studies in order to solve the above problem, and found that, when a gas container that is made of manganese steel and is characterized in that only a small amount of aluminum adheres to the inner surface of the gas container, is filled with a fluorohydrocarbon compound represented by C₄H₉F or C₅H₁₁F, it is possible to maintain the purity of the fluorohydrocarbon compound with which the gas container is filled. This finding has led to the completion of the invention.

One aspect of the invention provides the following fluorohydrocarbon compound-filled gas container (see (1) to (8)).
(1) A fluorohydrocarbon compound-filled gas container obtained by filling a gas container with a fluorohydrocarbon compound, the gas container being made of manganese steel, the amount of aluminum adhering to the inner surface of the gas container as measured by XPS analysis being 1 mol % or less, and the fluorohydrocarbon compound being a compound represented by C₄H₉F or C₅H₁₁F.
(2) The fluorohydrocarbon compound-filled gas container according to (1), wherein the inner surface of the gas container has a maximum height (Rmax) of 25 μm or less.
(3) The fluorohydrocarbon compound-filled gas container according to (1) or (2), wherein the inner surface of the gas container has been subjected to a polishing process that utilizes abrasive media.
(4) The fluorohydrocarbon compound-filled gas container according to any one of (1) to (3), wherein the fluorohydrocarbon compound is a compound in which a fluorine atom is not bonded to a carbon atom situated at a molecular terminal.
(₅) The fluorohydrocarbon compound-filled gas container according to any one of (1) to (4), wherein the fluorohydrocarbon compound is a compound selected from the group consisting of 2-fluorobutane, 2-fluoro-2-methylpropane, and 2-fluoropentane.
(6) The fluorohydrocarbon compound-filled gas container according to any one of (1) to (5), wherein the fluorohydrocarbon compound with which the gas container is filled has a purity (α) of 99.90 vol % or more.
(7) The fluorohydrocarbon compound-filled gas container according to (6), wherein the fluorohydrocarbon compound included in the fluorohydrocarbon compound-filled gas container has a purity (β) of 99.90 vol % or more when the fluorohydrocarbon compound-filled gas container has been allowed to stand at 23° C. for 30 days after the gas container has been filled with the fluorohydrocarbon compound.
(8) The fluorohydrocarbon compound-filled gas container according to (7), wherein the difference (α-β) between the purity (α) and the purity (β) is less than 0.02 percentage points.

### Advantageous Effects of Invention

One aspect of the invention thus provides a fluorohydrocarbon compound-filled gas container that is obtained by filling a gas container with a fluorohydrocarbon compound represented by C₄H₉F or C₅H₁₁F, and suppresses or reduces a decrease in the purity of the fluorohydrocarbon compound with which the gas container is filled.

### DESCRIPTION OF EMBODIMENTS

A fluorohydrocarbon compound-filled gas container (hereinafter may be referred to as “filled gas container”) according to one embodiment of the invention is obtained by filling a gas container with a fluorohydrocarbon compound, the gas container being made of manganese steel, the amount of aluminum adhering to the inner surface of the gas container as measured by XPS analysis (X-ray photoelectron spectroscopy) being 1 mol % or less, and the fluorohydrocarbon compound being a compound represented by C₄H₉F or C₅H₁₁F (hereinafter may be referred to as “fluorohydrocarbon compound (I)”).

### Gas Container

The gas container that forms the filled gas container according to one embodiment of the invention is made of manganese steel, and the amount of aluminum adhering to the inner surface of the gas container as measured by XPS analysis is 1 mol % or less.

A gas container is normally made of manganese steel or chromium-molybdenum steel. The gas container used in connection with one embodiment of the invention is made of manganese steel. When the gas container made of manganese steel is used, it is possible to suppress or reduce the decomposition of the fluorohydrocarbon compound (I) (with which the gas container is filled), and prevent a decrease in the purity of the fluorohydrocarbon compound (I), even when the filled gas container according to one embodiment of the invention is stored for a long time.

The gas container made of manganese steel is not particularly limited. A known gas container made of manganese steel may be used.

It is preferable that the inner surface of the gas container has been subjected to a polishing process. It is possible to suppress or reduce the adsorption of water and an impurity gas by subjecting the inner surface of the gas container to a polishing process. Therefore, it is possible to prevent a decrease in the purity of the fluorohydrocarbon compound (I) that may occur when water and an impurity gas are mixed in the fluorohydrocarbon compound (I), by filling the gas container of which the inner surface has been subjected to a polishing process, with the fluorohydrocarbon compound (I).

The maximum height (Rmax) of the inner surface of the gas container is preferably 25 μm or less, and more preferably 5 μm or less. The lower limit of the maximum height (Rmax) is not particularly limited, but is normally 1 μm or more.

It is commonly considered that a gas container of which the inner surface has a small maximum height (Rmax) is suitable as a high-purity gas container. The filled gas container according to one embodiment of the invention can sufficiently maintain the purity of the fluorohydrocarbon compound at a high level even when the maximum height (Rmax) of the inner surface of the gas container is not necessarily reduced. For example, the filled gas container according to one embodiment of the invention can maintain the purity of the fluorohydrocarbon compound at a high level for a long time even when the inner surface of the gas container has a maximum height (Rmax) of more than 3 μm. It is preferable that the inner surface of the gas container have a maximum height (Rmax) of 4 μm or more taking account of the production cost and the production time of the gas container.

The maximum height of the inner surface of the gas container may be measured by using a surface roughness tester.

It is preferable to use a polishing process that utilizes abrasive media since the inner surface of the gas container can be efficiently polished.

Examples of the polishing process that utilizes abrasive media include a barrel finishing process.

The inner surface of the gas container may be subjected to the barrel finishing process using a method that places abrasive media, a solvent, an additive, and the like in the gas container, seals the gas container, rotates the gas container at a high speed by combining a rotational motion and an orbital motion so that the abrasive media come in contact with the inner surface of the gas container, to polish the inner surface of the gas container, for example.

The abrasive media used for the polishing process are not particularly limited. Known abrasive media may be used. Note that it is necessary to select appropriate abrasive media corresponding to the polishing process (as described later) in order to reduce the amount of aluminum adhering to the inner surface of the gas container.

Examples of a material that forms the abrasive media include diamond, zirconia, alumina, silica, silicon nitride, silicon carbide, silica-alumina, iron, carbon steel, chrome steel, stainless steel, and the like.

The shape and the particle size of the abrasive media are not particularly limited.

The abrasive media may have a spherical shape, a quadrangular prism shape, a triangular prism shape, a triangular pyramid shape, or the like.

The particle size of the abrasive media is normally 0.1 μm to 100 mm. When the abrasive media does not have a spherical shape, the particle size of the abrasive media refers to the average value of the length of the long side and the length of the short side of the abrasive media measured using a microscope or the like.

The abrasive media may be used either alone or in combination. It is preferable to use a plurality of types of abrasive media that differ in particle size in combination since the polishing process can be efficiently performed. For example, the polishing process can be efficiently performed by utilizing abrasive media having a particle size of 1 to 20 mm and abrasive media having a particle size of 1 to 100 μm in combination.

The solvent used for the polishing process is not particularly limited. Water is normally used as the solvent.

Examples of the additive used for the polishing process include a pH-adjusting agent, a surfactant, a rust preventive, and the like.

The amounts of the abrasive media, the solvent, the additive, and the like, the rotational speed, the processing time, and the like when the barrel finishing process is used are not particularly limited. Known conditions may be appropriately used.

The amount of aluminum adhering to the inner surface of the gas container used in connection with one embodiment of the invention, as measured by XPS analysis, is 1 mol % or less, preferably 0.5 mol % or less, and more preferably 0.1 mol % or less. The lower limit of the amount of aluminum adhering to the inner surface of the gas container is not particularly limited, but is normally 0.05 mol % or more.

When the amount of aluminum adhering to the inner surface of the gas container is 1 mol % or less, it is possible to suppress or reduce the decomposition of the fluorohydrocarbon compound (I) (with which the gas container is filled), and prevent a decrease in the purity of the fluorohydrocarbon compound (I), even when the filled gas container according to one embodiment of the invention is stored for a long time.

Note that the term “aluminum” used herein in connection with the amount of aluminum adhering to the inner surface of the gas container, refers to “aluminum element”. It is conjectured that aluminum metal or an aluminum compound adheres to the inner surface of the gas container.

It is conjectured that aluminum metal or an aluminum compound that adheres to the inner surface of the gas container, functions as a catalyst that promotes dehydrofluorination of the fluorohydrocarbon compound (I).

Therefore, it is considered that the filled gas container according to one embodiment of the invention that utilizes the gas container that is characterized in that a substantial amount of aluminum is not present on the inner surface, can suppress or reduce the decomposition of the fluorohydrocarbon compound (I) (with which the gas container is filled).

The amount of aluminum adhering to the inner surface of the gas container may be measured using the method described later in connection with the examples.

The gas container that is characterized in that the amount of aluminum adhering to the inner surface is 1 mol % or less, may be produced using a method that subjects the inner surface of the gas container to the polishing process using abrasive media that do not include aluminum (method 1), or a method that subjects the inner surface of the gas container to the polishing process using abrasive media that include aluminum, and subjects the inner surface of the gas container to a chemical polishing process using a chemical polishing solution (method 2).

The abrasive media that do not include aluminum refer to abrasive media having an aluminum element content of 100 ppm by weight or less, and the abrasive media that include aluminum refer to abrasive media having an aluminum element content of more than 100 ppm by weight.

The term “aluminum element content” used herein refers to the total content of aluminum metal and an aluminum compound. Note that the term “aluminum element content” used herein normally refers to the content of an aluminum element included in an aluminum compound (alumina).

The aluminum element content in the abrasive media may be quantitatively determined by X-ray fluorescence analysis (XRF analysis), for example.

Since the method 1 subjects the inner surface of the gas container to the polishing process using abrasive media that do not include aluminum, aluminum does not remain on the inner surface of the gas container. Therefore, it is possible to efficiently obtain a gas container that is characterized in that the amount of aluminum adhering to the inner surface is 1 mol % or less, by utilizing the method 1.

It is preferable that the abrasive media that do not include aluminum (that are used for the method 1) include iron as the main component. The expression “includes iron as the main component” used herein in connection with abrasive media means that the iron element content in the abrasive media is 50 wt % or more.

Examples of the abrasive media that include iron as the main component, include abrasive media made of iron, abrasive media made of carbon steel, abrasive media made of chrome steel, and abrasive media made of stainless steel. Among these, abrasive media made of carbon steel are preferable.

Since the method 2 subjects the inner surface of the gas container to the polishing process using abrasive media that include aluminum, aluminum remains on the inner surface of the gas container immediately after completion of the polishing process. Therefore, the method 2 subjects the inner surface of the gas container to a chemical polishing process using a chemical polishing solution after completion of the polishing process. For example, when alumina or the like adheres to the inner surface of the gas container, it is possible to decompose and remove the alumina or the like by subjecting the inner surface of the gas container to the chemical polishing process, and obtain a gas container that is characterized in that the amount of aluminum adhering to the inner surface is 1 mol % or less.

It is known that the inner surface of a gas container can be more effectively smoothed by utilizing abrasive media having a high aluminum content (having an aluminum content of 99 wt % or more) (abrasive media having high alumina purity). In this case, however, it is normally necessary to provide a plurality of types of abrasive media that differ in aluminum content, and repeat the polishing process a plurality of times while changing the abrasive media. Therefore, this method is not preferable from the viewpoint of cost and production time.

In particular, the abrasive media used for the method 2 need not have a significantly high aluminum content, and it suffices to use abrasive media used for a normal polishing process since (i) it is unnecessary to considerably smooth the inner surface of the gas container used in connection with the invention (i.e., it suffices that the inner surface of the gas container be smooth to a certain extent), and (ii) it may be difficult to adjust the amount of aluminum adhering to the inner surface of the gas container to 1 mol % or less by means of the chemical polishing process when the polishing process has been performed using abrasive media having a high aluminum content.

Examples of the chemical polishing solution used for the chemical polishing process include an acidic polishing solution that includes hydrochloric acid, phosphoric acid, nitric acid, sulfuric acid, or hydrofluoric acid.

The chemical polishing solution may include an additive such as a surfactant, a viscosity controller, and a brightener.

The chemical polishing process may be effected by bringing the chemical polishing solution into contact with the inner surface of the gas container, for example.

The chemical polishing process may be effected directly after removing the contents (e.g., abrasive media) from the gas container, or may be effected after removing the contents (e.g., abrasive media) from the gas container, and washing the gas container with purified water or the like.

The chemical polishing process may be effected at an arbitrary temperature, but is normally effected at 80 to 150° C., and preferably 80 to 120° C.

The chemical polishing process may be effected for an arbitrary time depending on the chemical polishing solution, but is normally effected for 30 seconds to 60 minutes, and preferably 1 to 10 minutes.

After completion of the process that utilizes the method 1 or 2, the inside of the gas container is washed with water, a water-soluble organic solvent, or the like according to an ordinary method. After providing a valve to the gas container, the inside of the gas container is dried using a vacuum heating-drying method or the like to obtain a gas container that is used in connection with one embodiment of the invention.

The washing operation and the drying operation may be performed according to an ordinary method.

### Fluorohydrocarbon Compound

The fluorohydrocarbon compound which is included in the filled gas container according to one embodiment of the invention and with which the gas container is filled, is a compound represented by C₄H₉F or C₅H₁₁F (fluorohydrocarbon compound (I)).

Examples of the compound represented by C₄H₉F include 1-fluorobutane, 2-fluorobutane, 1-fluoro-2-methylpropane, and 2-fluoro-2-methylpropane.

Examples of the compound represented by C₅H₁₁F include 1-fluoropentane, 2-fluoropentane, 3-fluoropentane, 1-fluoro-2-methylbutane, 1-fluoro-3-methylbutane, 2-fluoro-2-methylbutane, 2-fluoro-3-methylbutane, and 1-fluoro-2,2-dimethylpropane.

Among these, (as described later) a compound in which a fluorine atom is not bonded to a carbon atom situated at a molecular terminal (hereinafter may be referred to as “fluorohydrocarbon compound (II)”) is preferable as the fluorohydrocarbon compound (I) since the advantageous effects of the invention can be more significantly achieved.

The fluorohydrocarbon compound (II) is normally decomposed more easily as compared with a fluorohydrocarbon compound in which a fluorine atom is bonded to a carbon atom situated at a molecular terminal.

Therefore, it is difficult to maintain the purity of the fluorohydrocarbon compound (II) for a long time in a state in which a gas container is filled with the fluorohydrocarbon compound (II).

However, since the gas container used in connection with one embodiment of the invention is made of manganese steel, and aluminum adheres to the inner surface of the gas container to only a small extent, it is possible to maintain the purity of the fluorohydrocarbon compound (II) for a long time in a state in which the gas container is filled with the fluorohydrocarbon compound (II).

Examples of the fluorohydrocarbon compound (II) that may be used in connection with one embodiment of the invention include 2-fluorobutane, 2-fluoro-2-methylpropane, 2-fluoropentane, 3-fluoropentane, 2-fluoro-2-methylbutane, and 2-fluoro-3-methylbutane. Among these, 2-fluorobutane, 2-methyl-2-fluoropropane, and 2-fluoropentane are preferable, and 2-fluorobutane is more preferable.

### Filled Gas Container

The filled gas container according to one embodiment of the invention is obtained by filling the gas container with the fluorohydrocarbon compound (I).

The gas container may be filled with the fluorohydrocarbon compound (I) using an arbitrary method. The gas container may be filled with the fluorohydrocarbon compound (I) using a known method.

The purity (α) of the fluorohydrocarbon compound (I) with which the gas container is filled, is preferably 99.90 vol % or more, and more preferably 99.95 vol % or more.

The filled gas container according to one embodiment of the invention is characterized in that the fluorohydrocarbon compound (I) that is included in the filled gas container is not easily decomposed, and rarely decreases in purity.

The purity (β) of the fluorohydrocarbon compound (I) included in the filled gas container is preferably 99.90 vol % or more, and more preferably 99.95 vol % or more, when the filled gas container has been allowed to stand at 23° C. for 30 days after the gas container has been filled with the fluorohydrocarbon compound (I).

The difference (α-β) between the purity (α) and the purity (β) is preferably less than 0.02 percentage points, and more preferably less than 0.01 percentage points. The purity of the fluorohydrocarbon compound (I) is measured by gas chromatography under the conditions described later.

As described above, the filled gas container according to one embodiment of the invention can maintain the purity of the fluorohydrocarbon compound (I) at a high level for a long time. Therefore, the filled gas container according to one embodiment of the invention is suitably used for an etching process that is used when producing a semiconductor device or the like.

### EXAMPLES

The invention is further described below by way of examples and comparative examples. Note that the invention is not limited to the following examples.

### Gas Chromatography

In the examples and the comparative examples, the purity of the fluorohydrocarbon compound, and the amount of the decomposition product (dehydrofluorinated compound) of the fluorohydrocarbon compound were determined by gas chromatography (GC analysis).

The following GC analysis conditions were used.
Device: Agilent (registered trademark) 7890A manufactured by Agilent Technologies
Column: Inert Cap (registered trademark) 1 manufactured by GL Sciences Inc. (length: 60 m, inner diameter: 0.25 mm, thickness: 1.5 μm)
Column temperature: The column was held at 40° C. for 20 minutes.
Injection temperature: 80° C.
Carrier gas: nitrogen
Split ratio: 40/1
Detector: FID
XPS analysis

In the examples and the comparative examples, the amount of aluminum adhering to the inner surface of the gas container was determined by XPS analysis. More specifically, the amount of aluminum was determined by calculating the peak area intensity of each detected element using Multipak software provided to the device, and calculating the amount of aluminum using a relative response factor method.

The following XPS analysis conditions were used.
1. Device
PHI 5000 VersaProbe II (manufactured by ULVAC-PHI, Incorporated)
Atmosphere: vacuum (<1.0×10⁶ Pa)
X-ray source: monochromatized Al Ka (1486.6 eV)
Spectrometer: electrostatic concentric hemispherical spectrometer
2. Measurement conditions
X-ray beam diameter: 100 μm (25 W, 15 kV)
Signal capture angle: 45.0°
Pass energy: 23.5 eV
Measurement energy range:
Al2p 68 to 82 eV
Cr2p 570 to 584 eV
Mn2p 632 to 648 eV
Fe2p 704 to 720 eV
3. Sputtering conditions
Ion source: Ar_{2,500}⁺
Accelerating voltage: 10 kV
Sputtering area: 2 mm×2 mm
Sputtering time: 10 min
XRF analysis

The aluminum element content in the abrasive media used in the examples and the comparative examples was determined by XRF analysis using a fundamental parameter (FP) method that does not use a standard sample.

The following XRF analysis conditions were used.
Device: ZSX Primus (manufactured by Rigaku Corporation)
Atmosphere: vacuum
Sample diameter: 10 mm (drip filter paper was used)
Measurement conditions: EZ scan (F to U, standard)
Instruments and reagents
Gas container (1): gas container made of manganese steel, capacity: 10 L
Gas container (2): gas container made of chromium-molybdenum steel, capacity: 10 L
Abrasive media (1): carbon steel balls (“Steel Ball 5 mm” manufactured by Azuma Group), aluminum content: 100 ppm by weight or less
Abrasive media (2): alumina-containing abrasive media (“Alumina Ball 5 mm” manufactured by SINTO V-CERAX, LTD.), aluminum content: 93 wt %
Polishing aid (1): “GCP” manufactured by Tipton Corp.

### Example 1

The gas container (1) was charged with 15 kg of the abrasive media (1), 5 L of purified water, and 100 g of the polishing aid (1), and sealed so that the contents were held therein. The gas container was subjected to a barrel finishing process (rotational speed: 100 rpm, processing time: 1 hour) until the inner surface of the gas container had a maximum height (Rmax) of 5 μm.

After completion of the barrel finishing process, a sliding nozzle was inserted into the cylinder in a state in which the opening of the gas container faced downward, and high-temperature/high-pressure purified water and high-pressure isopropyl alcohol were injected to wash the inside of the gas container. After providing a valve to the gas container, the gas container was depressurized to 0.1 Pa, and heated to dry the inside of the gas container.

The above process was performed on two gas containers to obtain two polished gas containers.

One of the polished gas containers was cut to have a size of 2×2 cm using a laser cutter, and the resulting measurement sample was subjected to XPS analysis to determine the amount of aluminum adhering to the inner surface of the gas container.

The other polished gas container was connected to a gas feed line that was connected to a stainless steel tank (that had been subjected to electrolytic polishing) containing 2-fluorobutane (purity: 99.95 vol %, dehydrofluorinated compound content: 0.02 vol %). The gas feed line was subjected to a batch purging process (that fills the gas feed line with nitrogen gas, and evacuates the gas feed line), and the polished gas container was charged with 1 kg of 2-fluorobutane to obtain a 2-fluorobutane-filled gas container.

The 2-fluorobutane-filled gas container was allowed to stand at 23° C. for 30 days after the polished gas container had been filled with 2-fluorobutane, and the purity of 2-fluorobutane included in the gas container, and the dehydrofluorinated compound content were measured. The results are listed in Table 1.

### Comparative Example 1

The gas container (1) was charged with 5 kg of the abrasive media (2), 5 L of purified water, and 200 g of the polishing aid (1), and sealed so that the contents were held therein. The gas container was subjected to a barrel finishing process (rotational speed: 100 rpm, processing time: 1 hour) until the inner surface of the gas container had a maximum height (Rmax) of 25 μm.

After completion of the barrel finishing process, a sliding nozzle was inserted into the cylinder in a state in which the opening of the gas container faced downward, and high-temperature/high-pressure purified water and high-pressure isopropyl alcohol were injected to wash the inside of the gas container. After providing a valve to the gas container, the gas container was depressurized to 0.1 Pa, and heated to dry the inside of the gas container.

The above process was performed on two gas containers to obtain two polished gas containers. The amount of aluminum adhering to the inner surface of the gas container, the purity of 2-fluorobutane included in the gas container, and the dehydrofluorinated compound content were measured in the same manner as in Example 1. The results are listed in Table 1.

### Comparative Example 2

Two polished gas containers were obtained in the same manner as in Example 1, except that the gas container (2) was used instead of the gas container (1), and the amount of aluminum adhering to the inner surface of the gas container, the purity of 2-fluorobutane included in the gas container, and the dehydrofluorinated compound content were measured using the resulting polished gas containers. The results are listed in Table 1.

### Comparative Example 3

Two polished gas containers were obtained in the same manner as in Comparative Example 1, except that the gas container (2) was used instead of the gas container (1), and the amount of aluminum adhering to the inner surface of the gas container, the purity of 2-fluorobutane included in the gas container, and the dehydrofluorinated compound content were measured using the resulting polished gas containers. The results are listed in Table 1.

TABLE 1

| | | | Comparative | Comparative | Comparative |
|---|---|---|---|---|---|
| | | Example 1 | Example 1 | Example 2 | Example 3 |
| Gas container | Material | Manganese steel | | Chromium-molybdenum steel | |
| | Abrasive media (barrel | Abrasive media (1) | Abrasive media (2) | Abrasive media (1) | Abrasive media (2) |
| | finishing process) | | | | |
| | Chemical polishing | Not performed | Not performed | Not performed | Not performed |
| | process | | | | |
| | Amount of aluminum | Less than 1 mol % | 12 mol % | Less than 1 mol % | 11 mol % |
| | adhering to inner surface | | | | |
| | of container | | | | |
| Fluorohydrocarbon | Type | 2-Fluorobutane | | | |
| compound | Purity (α) before filling | 99.95% | 99.93% | 99.91% | 99.92% |
| | Purity (β) when 30 days | 99.95% | 85.68% | 99.85% | 73.21% |
| | had elapsed after filling | | | | |
| | α-β | 0.00 | 14.25 | 0.06 | 26.71 |

| | | | | |
|---|---|---|---|---|
| Dehydrofluorinated compound content | 0.02% | 0.02% | 0.03% | 0.04% |
| in gas before filling | | | | |
| Dehydrofluorinated compound content in gas | 0.02% | 14.27% | 0.09% | 26.75% |
| when 30 days had elapsed after filling | | | | |

The following were confirmed from the results listed in Table 1.

When the 2-fluorobutane-filled gas container of Example 1 was allowed to stand for 30 days, 2-fluorobutane was decomposed to only a small extent, and maintained high purity.

When the 2-fluorobutane-filled gas container of Comparative Example 1 was allowed to stand for 30 days, 2-fluorobutane was significantly decomposed since the amount of aluminum adhering to the inner surface of the gas container was large.

When the 2-fluorobutane-filled gas container of Comparative Example 2 was allowed to stand for 30 days, 2-fluorobutane was significantly decomposed since the gas container was made of chromium-molybdenum steel.

When the 2-fluorobutane-filled gas container of Comparative Example 3 was allowed to stand for 30 days, 2-fluorobutane was decomposed to a large extent since the amount of aluminum adhering to the inner surface of the gas container, and the material forming the gas container fall outside the scope of the invention.

1. A fluorohydrocarbon compound-filled gas container obtained by filling a gas container with a fluorohydrocarbon compound, the gas container being made of manganese steel, an amount of aluminum adhering to an inner surface of the gas container as measured by XPS analysis being 1 mol % or less, and the fluorohydrocarbon compound being a compound represented by C₄H₉F or C₅H₁₁F.

2. The fluorohydrocarbon compound-filled gas container according to claim 1, wherein the inner surface of the gas container has a maximum height (Rmax) of 25 μm or less.

3. The fluorohydrocarbon compound-filled gas container according to claim 1, wherein the inner surface of the gas container has been subjected to a polishing process that utilizes abrasive media.

4. The fluorohydrocarbon compound-filled gas container according to claim 1, wherein the fluorohydrocarbon compound is a compound in which a fluorine atom is not bonded to a carbon atom situated at a molecular terminal.

5. The fluorohydrocarbon compound-filled gas container according to claim 1, wherein the fluorohydrocarbon compound is a compound selected from a group consisting of 2-fluorobutane, 2-fluoro-2-methylpropane, and 2-fluoropentane.

6. The fluorohydrocarbon compound-filled gas container according to claim 1, wherein the fluorohydrocarbon compound with which the gas container is filled has a purity (α) of 99.90 vol % or more.

7. The fluorohydrocarbon compound-filled gas container according to claim 6, wherein the fluorohydrocarbon compound included in the fluorohydrocarbon compound-filled gas container has a purity (β) of 99.90 vol % or more when the fluorohydrocarbon compound-filled gas container has been allowed to stand at 23° C. for 30 days after the gas container has been filled with the fluorohydrocarbon compound.

8. The fluorohydrocarbon compound-filled gas container according to claim 7, wherein a difference (α-β) between the purity (α) and the purity (β) is less than 0.02 percentage points.
